(19) United States
(12) Patent Application Publication
(10) Pub. No.: US 2021/0159741 A1
(43) Pub. Date: May 27, 2021

(54) STATOR, ELECTRIC MACHINE, AIRCRAFT COMPRISING AN ELECTRIC MACHINE, AND METHOD FOR PRODUCING A STATOR

(71) Applicant: Rolls-Royce Deutschland Ltd & Co KG, Blankenfelde-Mahlow (DE)

(72) Inventor: Stefan Walter, Nürnberg (DE)

(21) Appl. No.: 17/047,842

(22) PCT Filed: Apr. 15, 2019
(86) PCT No.: PCT/EP2019/059705

§ 371 Date: Oct. 15, 2020

(30) Foreign Application Priority Data
Apr. 17, 2018 (DE) 10 2018 205 806.7

(51) Int. Cl. H02K 1/14; H02K 15/02; B64D 27/24; B64C 11/00

(52) U.S. Cl. CPC H02K 1/148; H02K 15/022; B64D 2027/026; B64C 11/00; B64D 27/24

(57) ABSTRACT

The disclosure relates to a stator for an electric machine. The stator includes a stator yoke ring for receiving stator coils, characterized by: at least one stator coil carrier unit for receiving coil windings, which is configured to be plugged detachably—as a whole or with a first coil body element—on the stator yoke ring in the radial direction. The disclosure also relates to an electric machine and an electric or hybrid-electric aircraft. The disclosure further relates to a method for producing a stator.

The present patent document is a § 371 nationalization of PCT Application Serial No. PCT/EP2019/059705, filed Apr. 15, 2019, designating the United States, which is hereby incorporated by reference, and this patent document also claims the benefit of German Patent Application No. 10 2018 205 806.7, filed Apr. 17, 2018, which is also hereby incorporated by reference.

### TECHNICAL FIELD

The disclosure relates to a stator for an electrical machine, wherein the stator includes a stator yoke ring for receiving stator coils. The disclosure further relates to an electrical machine including a stator of this kind and also to an aircraft including an electrical machine. The disclosure also relates to a method for producing a stator.

### BACKGROUND

In the case of electrical machines, (e.g., electric motors such as asynchronous machines or permanent-magnet synchronous machines with concentrated stator windings), the damaged coil former may be replaced only with a high level of technical effort due to the pole geometry in the event of an insulation fault (e.g., due to a short between turns). In the case of the conventional winding process of concentrated windings around individual poles (e.g., the conductors of a coil are wound directly around each individual stator pole instead of being inserted lengthways into the slot as in the case of distributed windings), there is also the risk that the electrical insulation of the coil wires may be damaged because the windings are wound around the partly sharp-edged pole body with expenditure of a high level of force.

Particularly in aviation applications, the requirements in terms of reliability and availability are higher than in the rail or automotive industries.

In the case of electrical machines with known, unsegmented stators, the problem cannot be solved satisfactorily without a high level of expenditure on expansion and an associated risk of damage to surrounding components.

In the case of stators which are composed of several individual poles, it is possible to remove a single pole. However, given a conventional pole geometry, the pole shoe prevents the damaged coil from being easily withdrawn. Instead, the damaged coil has to be either unwound or cut open.

Stators of this kind are described in patent documents U.S. Pat. No. 6,975,057 B2 and U.S. Pat. No. 7,247,967 B2.

### SUMMARY

The object of the disclosure is to specify a solution in which a defective coil of a stator may be removed from a stator pole and replaced with little effort for maintenance purposes.

According to the disclosure, the stated object is achieved by the stator, the electrical machine, the aircraft, and the method disclosed herein. The scope of the present disclosure is defined solely by the appended claims and is not affected to any degree by the statements within this summary. The present embodiments may obviate one or more of the drawbacks or limitations in the related art.

According to the disclosure, the stator pole or parts of the stator pole are of exchangeable design, e.g., they may be detachably connected to the stator yoke ring, wherein the stator poles may be plug-connected from the radial direction (e.g., perpendicular to the stator axis). An air-core coil may therefore be pushed onto the stator pole before assembly.

The disclosure relates to a stator for an electrical machine. The stator has a stator yoke ring for receiving stator coils. At least one stator coil carrier unit (e.g., stator pole) is provided for receiving coil turns. The stator coil carrier unit as a whole or by way of a sub-unit (e.g., first coil former element) is detachably placed onto the stator yoke ring from the radial direction.

The disclosure provides the advantage that, on the one hand, stator poles may be easily repaired and, on the other hand, air-core coils may be pushed on very easily.

In one development, the stator may have air-core coils which may be pushed onto the stator coil carrier units before the stator coil carrier units or the sub-units are mounted. This provides the advantage that the possibility of damaging the insulation of coil windings is reduced.

In a further embodiment, the stator may have at least one connecting element which fixes the stator coil carrier unit in the stator yoke ring.

The stator may further have: a continuous prism-shaped first opening or continuous cutout in the stator coil carrier unit; and a continuous prism-shaped second opening in the stator yoke ring, wherein the connecting element is of prism-shaped design in such a way as to fix the stator coil carrier unit in the stator yoke ring by being inserted into the first and the second opening.

In an embodiment, there may be a lug which is formed in the stator coil carrier unit and in which the first opening or the cutout is formed.

In a further embodiment, there may be a slot which is formed in the stator yoke ring and into which the lug may be inserted.

The disclosure also relates to an electrical machine including a stator, wherein the electrical machine includes a rotor rotatably mounted within the stator.

In one development, the electrical machine may be an electric motor or a generator.

The disclosure also relates to an aircraft including an electrical machine, wherein the electrical machine is part of an electric or hybrid-electrical aircraft drive.

In a further refinement, the aircraft may be an airplane and the electric motor may drive a propeller.

The disclosure also relates to a method for producing a stator. The method includes: providing the stator yoke ring; providing stator coil carrier units; producing the air-core coils; pushing the air-core coils onto the stator coil carrier units; inserting the stator coil carrier units into the stator yoke ring; and fixing the stator coil carrier units by inserting the connecting elements into the first and second openings.

The disclosure also relates to a further method for producing a stator. The further method includes: providing the stator yoke ring; providing stator coil carrier units; producing the air-core coils; pushing the air-core coils onto the sub-units (e.g., second coil former elements) of the stator coil carrier units, which sub-units are connected to the stator yoke ring; inserting the sub-units through the air-core coils into the stator yoke ring; and fixing the sub-units by inserting the connecting elements into the cutouts and second openings.

### BRIEF DESCRIPTION OF THE DRAWINGS

Further special features and advantages of the disclosure become clear from the following explanations of two exemplary embodiments with reference to schematic drawings, in which:

FIG. 1 and FIG. 2 show cross sections of a portion of a stator, according to an example.

FIG. 3 and FIG. 4 show oblique views of a portion of a stator, according to an example.

FIG. 5 and FIG. 6 show cross sections of a stator yoke ring with stator poles, according to an example.

FIG. 7 and FIG. 8 show cross sections of a portion of a stator, according to an example.

FIG. 9 and FIG. 10 show oblique views of a portion of a stator, according to an example.

FIG. 11 shows the timing of assembly, according to an example.

FIG. 12 and FIG. 13 show cross sections of a stator yoke ring with stator poles, according to an example.

FIG. 14 shows a block diagram of an example of an electrical machine.

FIG. 15 shows an example of an aircraft including an electric motor.

### DETAILED DESCRIPTION

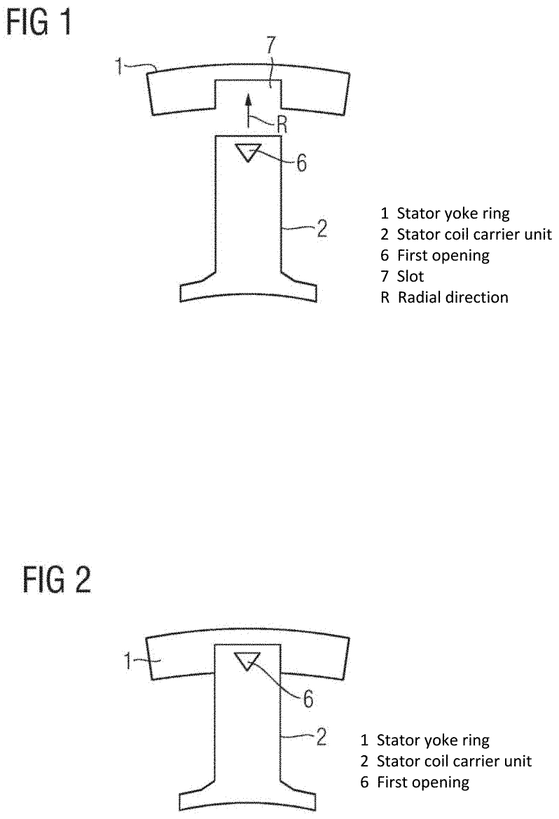

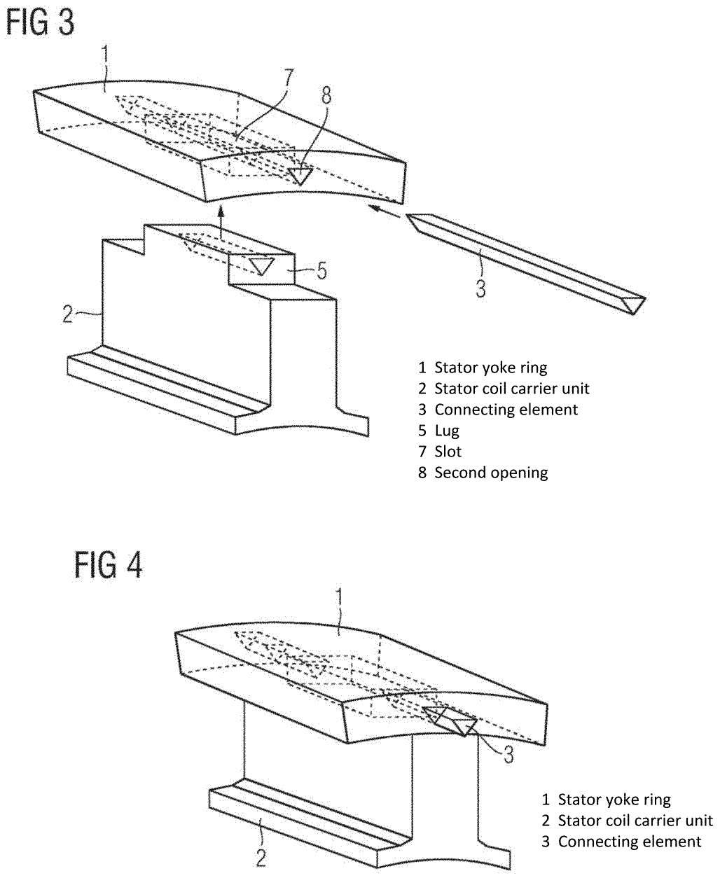

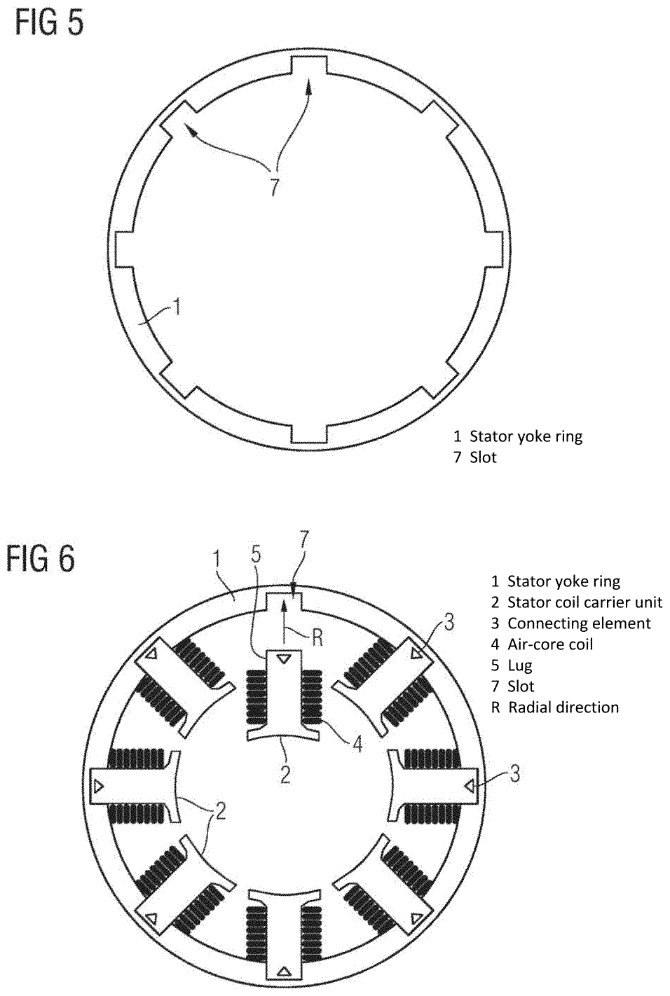

FIG. 1 to FIG. 6 show illustrations of a first embodiment variant. FIG. 1 and FIG. 2 each show a sectional view through a stator coil carrier unit 2 and a portion of the stator yoke ring 1. FIG. 3 and FIG. 4 show a three-dimensional view of a stator coil carrier unit 2 and a portion of the stator yoke ring 1. FIG. 5 shows a sectional view through a stator yoke ring 1 and FIG. 6 shows a sectional view through a stator yoke ring with the mounted stator coil carrier units 2 and the air-core coils 4.

The stator coil carrier units 2 (which may also be referred to as stator poles) are exchangeable and are placed into a slot 7 of the stator yoke ring 1 from the radial direction R and fixed against slipping out by a prism-shaped connecting element 3. To this end, the stator coil carrier unit 2 has a lug 5 with a first opening 6.

If the stator coil carrier unit 2 has been placed into the slot 7 from the radial direction, the connecting element 3 is pushed into the first opening 6 through a second opening 8 in the stator yoke ring 1, as a result of which the stator coil carrier unit 2 is fixed and firmly connected to the stator yoke ring 1. The connecting element 4 and the first and the second opening 6 and 8 have a triangular cross section, so that a connection which is secure against rotation may be established.

As depicted in FIG. 6, an air-core coil 4 is pushed onto the stator coil carrier unit 2 before it is installed. Then, all stator coil carrier units 2 together with air-core coils 4 are inserted into the stator yoke ring 1 and fixed with the connecting elements 3.

The main advantages of such a device include: the possibility of exchangeability of defective coil formers (e.g., stator coil carrier unit 2) in the event of a fault (e.g. short between turns); reduced maintenance effort owing to easier access to defective coil formers; separate winding process in the form of an air-core coil 4 (no individual coil winding necessary directly on the stator pole); reduction in the risk of damage to the electrical insulation during the air-core coil winding process; enabling a press fit owing to a continuous stator yoke ring in comparison to a single pole stator (no tolerance chain/setting processes which lead to a press-fit loss and with which torque may no longer be transmitted from the stator to the stator housing); and increased reliability and availability of an electrical machine during the entire service life.

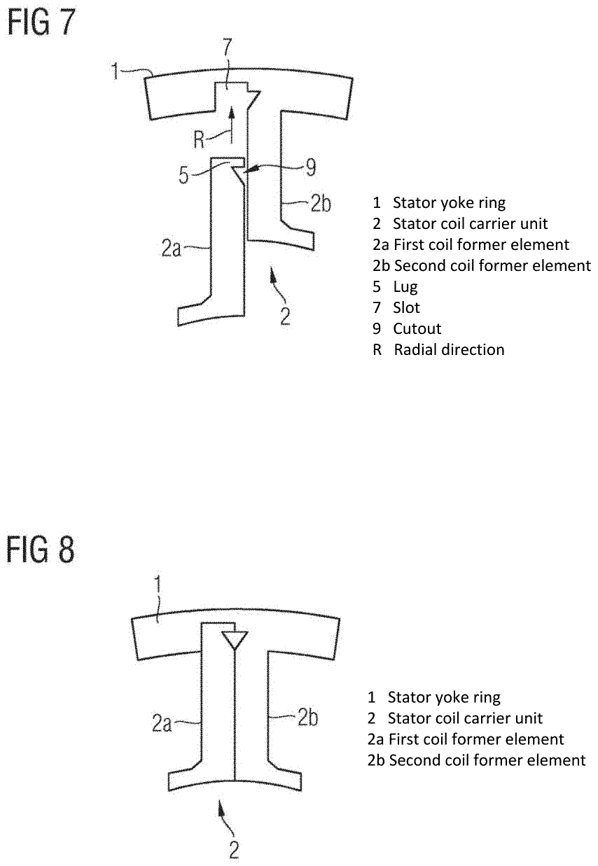

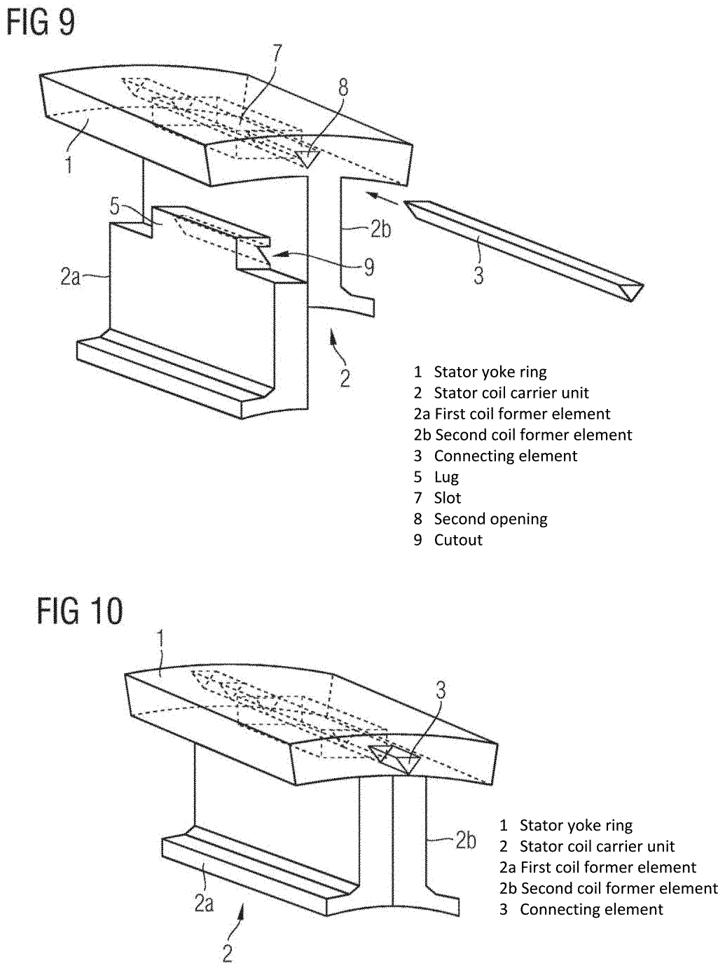

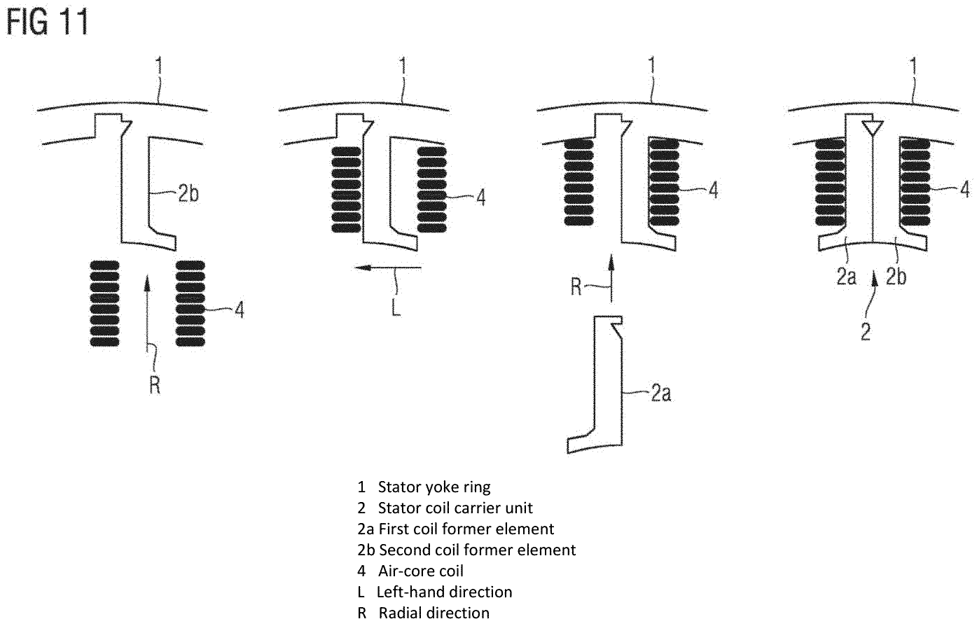

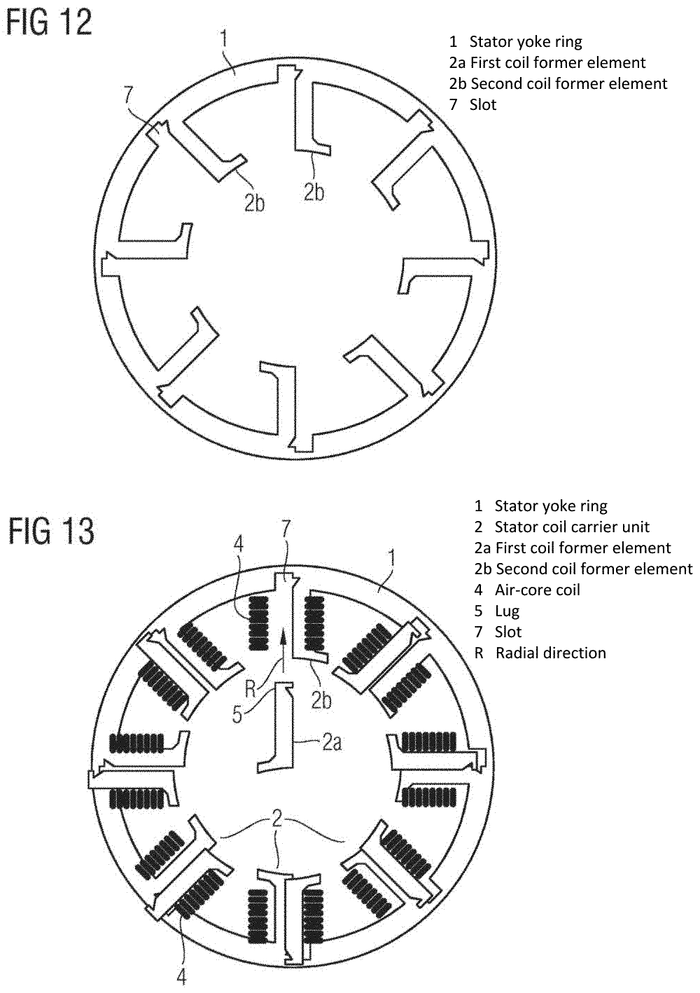

FIG. 7 to FIG. 13 show a further embodiment. FIG. 7 and FIG. 8 each show a sectional view through a stator coil carrier unit 2 and a portion of the stator yoke ring 1. FIG. 9 and FIG. 10 show a three-dimensional view of the stator coil carrier unit 2 and a portion of the stator yoke ring 1. FIG. 11 shows sectional views of how the air-core coil 4 is pushed onto a portion of the stator yoke ring 1 and fixed. FIG. 12 shows a sectional view through a stator yoke ring 1 and FIG. 13 shows a sectional view through a stator yoke ring 1 with the assembled stator coil carrier units 2 and the pushed-on air-core coils 4.

In contrast to the first embodiment, the stator coil carrier unit 2 is divided longitudinally and centrally into a first coil former element 2a and a second coil former element 2b. The first coil former element 2a is exchangeable (e.g., may be removed), whereas the second coil former element 2b is firmly connected to the stator yoke ring 1 or is formed in one piece with it.

As depicted in the drawings, the first coil former element 2a is pushed into the slot 7 of the stator yoke ring 1 in the radial direction R (e.g., perpendicular to the stator axis). To this end, the first coil former element 2a has a lug 5 which engages into the slot 7. The lug 5 is equipped with a cutout 9 into which the prism-shaped connecting element 3 is pushed through the second opening 8 of the stator yoke ring 1 and in this way fixes the first coil former 2a in the slot 7 and presses it flat against the second coil former element 2b. The connecting element 4 and also the cutout 9 and the second opening 8 have a triangular cross section, so that a connection which is secure against rotation may be established.

FIG. 11 shows the assembly sequentially from left to right. The air-core coil 4 is pushed onto the second coil former element 2b and then shifted to the left (direction L). Thereafter, the exchangeable first coil former element 2a is inserted into the stator yoke ring 1 in the radial direction R through the air-core coil 4. Finally, the first coil former element 2a is secured by the connecting element 3.

It is advantageous that the slot transverse forces are transmitted directly from the stator coil carrier units 2 to the stator yoke ring 1. In addition, the stator does not include any individual segments which, due to the fault tolerance chain and setting processes, may no longer guarantee a sufficiently high press fit.

An advantage of both embodiments is, amongst others, also that air-core coils 4 may be used, which air-core coils may be produced in a separate operation using a winding method that is gentler on and more cost-effective for their wire insulation.

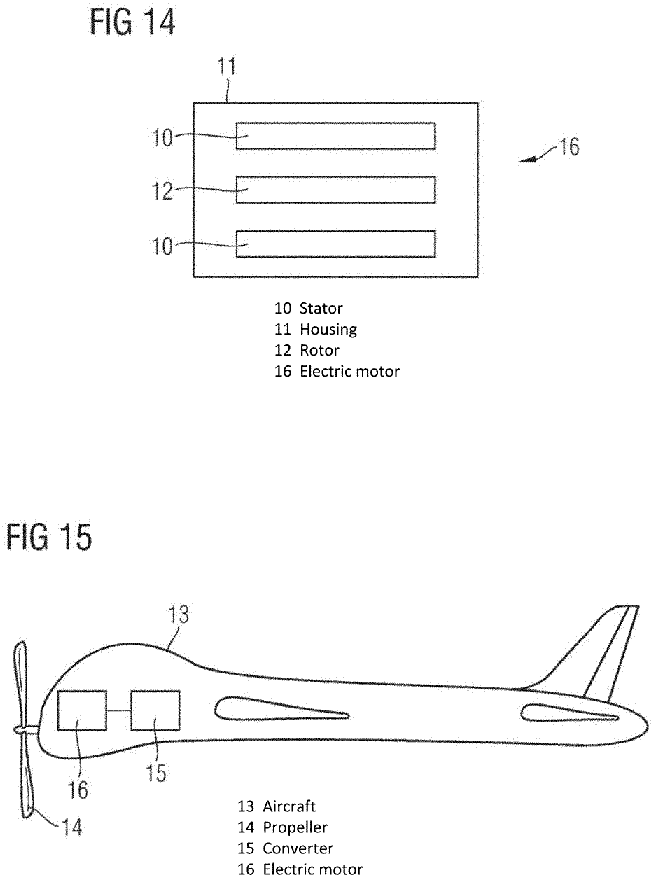

FIG. 14 shows a block diagram of an electrical machine, for example an electric motor 16. The stator 10 and the rotor 12 which is rotatably mounted in the stator are located in a housing 11. The stator 10 is designed in accordance with the embodiments and drawings in FIG. 1 to FIG. 13.

FIG. 15 shows an aircraft 13, for example an airplane, with an electric or hybrid-electric aircraft drive. The figure illustrates an electric motor 16 which sets a propeller 14 in rotation. The electric motor 16 is supplied with electrical power by a converter 15.

Although the disclosure has been described and illustrated more specifically in detail by the exemplary embodiments, the disclosure is not restricted by the disclosed examples and other variations may be derived therefrom by a person skilled in the art without departing from the scope of protection of the disclosure. It is therefore intended that the foregoing description be regarded as illustrative rather than limiting, and that it be understood that all equivalents and/or combinations of embodiments are intended to be included in this description.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1. A stator for an electrical machine, the stator comprising:
a stator yoke ring configured to receive stator coils; and
a stator coil carrier unit configured to receive coil turns,
wherein the stator coil carrier unit is configured to be detachably placed onto the stator yoke ring in a radial direction as a whole or by way of a first coil former element of the stator coil carrier unit.

2. The stator of claim 1, further comprising:
an air-core coil configured to be pushed onto the stator coil carrier unit before the stator coil carrier unit is mounted to the stator yoke ring.

3. The stator of claim 2, further comprising:
a connecting element configured to fix the stator coil carrier unit in the stator yoke ring.

4. The stator of claim 3, further comprising:
a continuous prism-shaped first opening in the stator coil carrier unit; and
a continuous prism-shaped second opening in the stator yoke ring,
wherein the connecting element is of prism-shaped design in such a way as to fix the stator coil carrier unit in the stator yoke ring by being inserted into the continuous prism-shaped first opening and the continuous prism-shaped second opening.

5. The stator of claim 4, further comprising:
a lug which is formed on the stator coil carrier unit and in which the continuous prism-shaped first opening is formed.

6. The stator of claim 1, further comprising:
an air-core coil configured to be pushed onto a second coil former element of the stator coil carrier unit,
wherein the second coil former element is connected to the stator yoke ring before the first coil former element is mounted to the stator yoke ring.

7. The stator of claim 6, further comprising:
a connecting element configured to fix the first coil former element in the stator yoke ring.

8. The stator of claim 7, further comprising:
a continuous prism-shaped cutout in the first coil former element; and
a continuous prism-shaped opening in the stator yoke ring,
wherein the connecting element is of prism-shaped design in such a way as to fix the first coil former element in the stator yoke ring by being inserted into the continuous prism-shaped cutout and the continuous prism-shaped opening.

9. The stator of claim 8, further comprising:
a lug which is formed on the first coil former element and in which the continuous prism-shaped cutout is formed.

10. The stator of claim 9, further comprising:
a slot which is formed in the stator yoke ring and into which the lug is configured to be inserted.

11. An electrical machine comprising:
a stator having:
a stator yoke ring configured to receive stator coils; and
a stator coil carrier unit configured to receive coil turns,
wherein the stator coil carrier unit is configured to be detachably placed onto the stator yoke ring in a radial direction as a whole or by way of a first coil former element of the stator coil carrier unit; and
a rotor which is rotatably mounted within the stator.

12. The electrical machine of claim 11, wherein the electrical machine is an electric motor.

13. An aircraft comprising:
an electrical machine having a stator and a rotor, wherein the rotor is rotatably mounted within the stator, and wherein the stator comprises:
a stator yoke ring configured to receive stator coils; and
a stator coil carrier unit configured to receive coil turns,
wherein the stator coil carrier unit is configured to be detachably placed onto the stator yoke ring in a radial direction as a whole or by way of a first coil former element of the stator coil carrier unit,
wherein the electrical machine is part of an electric or hybrid-electric aircraft drive.

14. The aircraft of claim 13, wherein the electrical machine is an electric motor,
wherein the aircraft is an airplane, and
wherein the electric motor is configured to drive a propeller of the airplane.

15. A method for producing a stator, the method comprising:
providing a stator yoke ring having continuous prism-shaped openings;
providing stator coil carrier units, wherein each stator coil carrier unit has a continuous prism-shaped opening;
providing air-core coils;
pushing the air-core coils onto the stator coil carrier units before the stator coil carrier units are mounted to the stator yoke ring;
inserting the stator coil carrier units into the stator yoke ring in a radial direction; and
fixing each stator coil carrier unit of the stator coil carrier units by inserting a prism-shaped connecting element into a continuous prism-shaped opening of the stator yoke ring and a respective continuous prism-shaped opening of a stator coil carrier unit of the stator coil carrier units.

16. A method for producing a stator, the method comprising:
providing a stator yoke ring having continuous prism-shaped openings;
providing first coil former elements, wherein each first coil former element has a continuous prism-shaped cutout;
providing air-core coils;
pushing the air-core coils onto second coil former elements connected to the stator yoke ring;
inserting the first coil former elements through the air-core coils into the stator yoke ring in a radial direction; and
fixing the first coil former elements by inserting prism-shaped connecting elements into the continuous prism-shaped cutouts of the stator yoke ring and the continuous prism-shaped openings of the first coil former elements.

17. The stator of claim 1, further comprising:
a connecting element configured to fix the stator coil carrier unit in the stator yoke ring.

18. The stator of claim 17, further comprising:
a continuous prism-shaped first opening in the stator coil carrier unit; and
a continuous prism-shaped second opening in the stator yoke ring,
wherein the connecting element is of prism-shaped design in such a way as to fix the stator coil carrier unit in the stator yoke ring by being inserted into the continuous prism-shaped first opening and the continuous prism-shaped second opening.

19. The stator of claim 18, further comprising:
a lug which is formed on the stator coil carrier unit and in which the continuous prism-shaped first opening is formed.

20. The stator of claim 19, further comprising:
a slot which is formed in the stator yoke ring and into which the lug is configured to be inserted.
